(19) United States
(12) Patent Application Publication
(10) Pub. No.: US 2014/0278955 A1
(43) Pub. Date: Sep. 18, 2014

(54) TUNABLE AD GENERATION

(71) Applicants: Valerie Nygaard, Saratoga, CA (US); Enoch Chen, San Jose, CA (US)

(72) Inventors: Valerie Nygaard, Saratoga, CA (US); Enoch Chen, San Jose, CA (US)

(73) Assignee: EBAY INC., SAN JOSE, CA (US)

(21) Appl. No.: 14/132,146

(22) Filed: Dec. 18, 2013

Related U.S. Application Data
(60) Provisional application No. 61/800,661, filed on Mar. 15, 2013.

(51) Int. Cl. G06Q 30/02

(52) U.S. Cl. CPC G06Q 30/0251
USPC 705/14.49

(57) ABSTRACT

A system and method of providing tunable generation of advertisements are disclosed. In some embodiments, a target advertisement goal for a website is received. The target advertisement goal comprises a first goal for a first type of advertisement and a second goal for a second type of advertisement. Advertisements to display on the website are determined based on the target advertisement goal. The advertisements are caused to be displayed on the website. In some embodiments, the first type of advertisement is an advertisement for merchandise offered for sale on the website, and the second type of advertisement is an advertisement for merchandise offered for sale on a different website.

### CROSS-REFERENCE TO RELATED APPLICATIONS

This application claims priority to U.S. Provisional Application No. 61/800,661, filed on Mar. 15, 2013, entitled, “TUNABLE AD GENERATION,” which is hereby incorporated by reference in its entirety as if set forth herein

### TECHNICAL FIELD

The present application relates generally to the technical field of data processing, and, in various embodiments, to systems and methods of providing tunable generation of advertisements.

### BACKGROUND

Presenting relevant advertisements to users in an effective way that leads to high conversion rates is challenging. Furthermore, determining what types of advertisements to display can be a complicated process.

### BRIEF DESCRIPTION OF THE DRAWINGS

Some embodiments of the present disclosure are illustrated by way of example and not limitation in the figures of the accompanying drawings, in which like reference numbers indicate similar elements and in which:

FIG. 1 is a block diagram depicting a network architecture of a system, according to some embodiments, having a client-server architecture configured for exchanging data over a network;

FIG. 2 is a block diagram depicting a various components of a network-based publisher, according to some embodiments;

FIG. 3 is a block diagram depicting an example embodiment of various tables that may be maintained within a database;

FIG. 4 illustrates a tunable advertisement system, in accordance with some embodiments;

FIG. 5 illustrates a graphical user interface for tuning advertisement space, in accordance with some embodiments;

FIG. 6 illustrates another graphical user interface for tuning advertisement space, in accordance with some embodiments;

FIG. 7 is a flowchart illustrating a method of providing tunable generation of advertisements, in accordance with some embodiments;

FIG. 8 illustrates a mapping of advertisements to purchase funnel stages, in accordance with some embodiments;

FIGS. 9A-9D illustrate different stages in a purchase funnel of a website, in accordance with some embodiments;

FIG. 10 is a flowchart illustrating a method of providing advertisements based on a purchase funnel of a website, in accordance with some embodiments; and

FIG. 11 shows a diagrammatic representation of a machine in the example form of a computer system within which a set of instructions may be executed to cause the machine to perform any one or more of the methodologies discussed herein, in accordance with an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

Systems and methods of providing tunable generation of advertisements are disclosed. The techniques disclosed herein can enable someone (e.g., an administrator) to set preferences or other goals for the mixture of different types of advertisements displayed on a website for a certain time period. For example, a determination can be made by one or more administrators of a website that the website has been receiving more than enough revenue from its merchandise sales, while receiving less than sufficient revenue from its advertising revenue, such as from advertisements for merchandise offered for sale on a different website. The administrator(s) can tune the generation of advertisements on the website for a certain preference for advertisements for merchandise offered for sale on different websites over advertisements for merchandise offered for sale on the website of the administrator(s). Additionally, the techniques disclosed herein can enable the tailoring of advertisements for a website based on what stage of a purchase funnel of the website a user is at on the website. These features will be discussed in further detail below.

In some embodiments, a method comprises receiving a target advertisement goal for a website. The target advertisement goal can comprise a first goal for a first type of advertisement and a second goal for a second type of advertisement. Advertisements to display on the website can be determined based on the target advertisement goal. The advertisements can be caused to be displayed on the website.

In some embodiments, the first goal comprises a revenue goal for the first type of advertisement, and the second goal comprises a revenue goal for the second type of advertisement. In some embodiments, the target advertisement goal comprises a ratio of the first type of advertisement to the second type of advertisement. In some embodiments, the first type of advertisement is an advertisement for merchandise offered for sale on the website, and the second type of advertisement is an advertisement for merchandise offered for sale on a different website. In some embodiments, determining the advertisements to display on the website comprises determining a total number of advertisements corresponding to the first type of advertisement to display for a predetermined period of time and a total number of advertisements corresponding to the second type of advertisement to display for the predetermined period of time.

In some embodiments, the method further comprises determining a purchase funnel stage for a user to whom one of the advertisements will be displayed. The determined purchase funnel stage can be one of a plurality of purchase funnel stages, where each purchase funnel stage corresponds to a distinct stage of depth into an e-commerce purchase process. The determination of the advertisements to display on the website can be further based on the determined purchase funnel stage. In some embodiments, the plurality of purchase funnel stages can comprise a search query submission stage corresponding to the user viewing a search page of the website before submitting a search query, a search results stage corresponding to the user viewing a search results page, a view item stage corresponding to the user viewing a page for an item offered for sale on the website and being presented with an option to purchase the item, and a purchase initiation stage corresponding to the user viewing a page for completing the purchase of the item subsequent to selecting the option to purchase the item. In some embodiments, the method further comprises storing a mapping of advertisements to purchase funnel stages. The determination of the advertisements to display on the website can be further based on the mapping of advertisements to purchase funnel stages.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

FIG. 1 is a network diagram depicting a client-server system 100, within which one example embodiment may be deployed. A networked system 102, in the example forms of a network-based marketplace or publication system, provides server-side functionality, via a network 104 (e.g., the Internet or a Wide Area Network (WAN)) to one or more clients. FIG. 1 illustrates, for example, a web client 106 (e.g., a browser, such as the Internet Explorer browser developed by Microsoft Corporation of Redmond, Wash. State) and a programmatic client 108 executing on respective client machines 110 and 112.

An API server 114 and a web server 116 are coupled to, and provide programmatic and web interfaces respectively to, one or more application servers 118. The application servers 118 host one or more marketplace applications 120 and payment applications 122. The application servers 118 are, in turn, shown to be coupled to one or more database servers 124 that facilitate access to one or more databases 126.

The marketplace applications 120 may provide a number of marketplace functions and services to users who access the networked system 102. The payment applications 122 may likewise provide a number of payment services and functions to users. The payment applications 122 may allow users to accumulate value (e.g., in a commercial currency, such as the U.S. dollar, or a proprietary currency, such as “points”) in accounts, and then later to redeem the accumulated value for products (e.g., goods or services) that are made available via the marketplace applications 120. While the marketplace and payment applications 120 and 122 are shown in FIG. 1 to both form part of the networked system 102, it will be appreciated that, in alternative embodiments, the payment applications 122 may form part of a payment service that is separate and distinct from the networked system 102.

Further, while the system 100 shown in FIG. 1 employs a client-server architecture, the embodiments are, of course not limited to such an architecture, and could equally well find application in a distributed, or peer-to-peer, architecture system, for example. The various marketplace and payment applications 120 and 122 could also be implemented as standalone software programs, which do not necessarily have networking capabilities.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 may, for example, be a seller application (e.g., the TurboLister application developed by eBay Inc., of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more promotional, marketplace, or payment functions that are supported by the relevant applications of the networked system 102.

FIG. 2 is a block diagram illustrating multiple marketplace and payment applications 120 and 122 that, in one example embodiment, are provided as part of the networked system 102. Alternate solutions may include other combinations of these modules. The applications 120 and 122 may be hosted on dedicated or shared server machines (not shown) that are communicatively coupled to enable communications between server machines. The applications 120 and 122 themselves are communicatively coupled (e.g., via appropriate interfaces) to each other and to various data sources, so as to allow information to be passed between the applications 120 and 122 or so as to allow the applications 120 and 122 to share and access common data. The applications 120 and 122 may, furthermore, access one or more databases 126 via the database servers 124. The slide checkout mechanism disclosed herein may be integrated with any or all of the applications described herein below. Some examples of such integration are provided; however, other applications may also have integrations consistent with this disclosure.

The networked system 102 may provide a number of publishing, listing, and price-setting mechanisms whereby a seller may list (or publish information concerning) goods or services for sale, a buyer can express interest in or indicate a desire to purchase such goods or services, and a price can be set for a transaction pertaining to the goods or services. To this end, the marketplace and payment applications 120 and 122 are shown to include at least one publication application 200 and one or more auction applications 202, which support auction-format listing and price setting mechanisms (e.g., English, Dutch, Vickrey, Chinese, Double, Reverse auctions etc.). The various auction applications 202 may also provide a number of features in support of such auction-format listings, such as a reserve price feature whereby a seller may specify a reserve price in connection with a listing and a proxy-bidding feature whereby a bidder may invoke automated proxy bidding.

A number of fixed-price applications 204 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings, and allow a buyer to purchase goods or services, which are also being offered for sale via an auction, for a fixed-price that is typically higher than the starting price of the auction.

Store applications 206 allow a seller to group listings within a “virtual” store, which may be branded and otherwise personalized by and for the seller. Such a virtual store may also offer promotions, incentives, and features that are specific and personalized to a relevant seller.

Reputation applications 208 allow users who transact, utilizing the networked system 102, to establish, build, and maintain reputations, which may be made available and published to potential trading partners. Consider that where, for example, the networked system 102 supports person-to-person trading, users may otherwise have no history or other reference information whereby the trustworthiness and credibility of potential trading partners may be assessed. The reputation applications 208 allow a user (e.g., through feedback provided by other transaction partners) to establish a reputation within the networked system 102 over time. Other potential trading partners may then reference such a reputation for the purposes of assessing credibility and trustworthiness.

Personalization applications 210 allow users of the networked system 102 to personalize various aspects of their interactions with the networked system 102. For example, a user may, utilizing an appropriate personalization application 210, create a personalized reference page on which information regarding transactions to which the user is (or has been) a party may be viewed. Further, a personalization application 210 may enable a user to personalize listings and other aspects of their interactions with the networked system 102 and other parties. The personalization application(s) 210 may integrate with the slide checkout mechanism such that the user's information is used to generate the selections and options available. In some embodiments, the user is able to specify their preferences, such as incorporate specific payment options, addresses and other considerations. For example, the user may specify that when a particular shipping address is selected, then a selection to identify the item as a gift will be presented on the display; when the user slides over the gift option, a gift receipt is provided with the item, or a gift card is provided with the item.

The networked system 102 may support a number of marketplaces that are customized, for example, for specific geographic regions. A version of the networked system 102 may be customized for the United Kingdom, whereas another version of the networked system 102 may be customized for the United States. Each of these versions may operate as an independent marketplace or may be customized (or internationalized) presentations of a common underlying marketplace. The networked system 102 may, accordingly, include a number of internationalization applications 212 that customize information (and/or the presentation of information) by the networked system 102 according to predetermined criteria (e.g., geographic, demographic or marketplace criteria). For example, the internationalization applications 212 may be used to support the customization of information for a number of regional websites that are operated by the networked system 102 and that are accessible via respective web servers 116.

Navigation of the networked system 102 may be facilitated by one or more navigation applications 214. For example, a search application (as an example of a navigation application 214) may enable key word searches of listings published via the networked system 102. A browse application may allow users to browse various category, catalogue, or inventory data structures according to which listings may be classified within the networked system 102. Various other navigation applications 214 may be provided to supplement the search and browsing applications.

In order to make the listings available via the networked system 102, as visually informing and attractive as possible, the applications 120 and 122 may include one or more imaging applications 216, which users may utilize to upload images for inclusion within listings. An imaging application 216 also operates to incorporate images within viewed listings. The imaging applications 216 may also support one or more promotional features, such as image galleries that are presented to potential buyers. For example, sellers may pay an additional fee to have an image included within a gallery of images for promoted items.

Listing creation applications 218 allow sellers to conveniently author listings pertaining to goods or services that they wish to transact via the networked system 102, and listing management applications 220 allow sellers to manage such listings. Specifically, where a particular seller has authored and/or published a large number of listings, the management of such listings may present a challenge. The listing management applications 220 provide a number of features (e.g., auto-relisting, inventory level monitors, etc.) to assist the seller in managing such listings. One or more post-listing management applications 222 also assist sellers with a number of activities that typically occur post-listing. For example, upon completion of an auction facilitated by one or more auction applications 202, a seller may wish to leave feedback regarding a particular buyer. To this end, a post-listing management application 222 may provide an interface to one or more reputation applications 208, so as to allow the seller to conveniently provide feedback regarding multiple buyers to the reputation applications 208.

Dispute resolution applications 224 provide mechanisms whereby disputes arising between transacting parties may be resolved. For example, the dispute resolution applications 224 may provide guided procedures whereby the parties are guided through a number of steps in an attempt to settle a dispute. In the event that the dispute cannot be settled via the guided procedures, the dispute may be escalated to a third party mediator or arbitrator.

A number of fraud prevention applications 226 implement fraud detection and prevention mechanisms to reduce the occurrence of fraud within the networked system 102.

Messaging applications 228 are responsible for the generation and delivery of messages to users of the networked system 102, such as, for example, messages advising users regarding the status of listings at the networked system 102 (e.g., providing “outbid” notices to bidders during an auction process or to providing promotional and merchandising information to users). Respective messaging applications 228 may utilize any one of a number of message delivery networks and platforms to deliver messages to users. For example, messaging applications 228 may deliver electronic mail (e-mail), instant message (IM), Short Message Service (SMS), text, facsimile, or voice (e.g., Voice over IP (VoIP)) messages via the wired (e.g., the Internet), Plain Old Telephone Service (POTS), or wireless (e.g., mobile, cellular, WiFi, WiMAX) networks.

Merchandising applications 230 support various merchandising functions that are made available to sellers to enable sellers to increase sales via the networked system 102. The merchandising applications 230 also operate the various merchandising features that may be invoked by sellers, and may monitor and track the success of merchandising strategies employed by sellers.

The networked system 102 itself, or one or more parties that transact via the networked system 102, may operate loyalty programs that are supported by one or more loyalty/promotions applications 232. For example, a buyer may earn loyalty or promotion points for each transaction established and/or concluded with a particular seller, and be offered a reward for which accumulated loyalty points can be redeemed.

A tunable advertisement system 234 may be configured to perform any combination of functions related to providing tunable generation of advertisements disclosed herein.

FIG. 3 is a high-level entity-relationship diagram, illustrating various tables 300 that may be maintained within the database(s) 126, and that are utilized by and support the applications 120 and 122. A user table 302 contains a record for each registered user of the networked system 102, and may include identifier, address and financial instrument information pertaining to each such registered user. A user may operate as a seller, a buyer, or both, within the networked system 102. In one example embodiment, a buyer may be a user that has accumulated value (e.g., commercial or proprietary currency), and is accordingly able to exchange the accumulated value for items that are offered for sale by the networked system 102.

The tables 300 also include an items table 304 in which are maintained item records for goods and services that are available to be, or have been, transacted via the networked system 102. Each item record within the items table 304 may furthermore be linked to one or more user records within the user table 302, so as to associate a seller and one or more actual or potential buyers with each item record.

A transaction table 306 contains a record for each transaction (e.g., a purchase or sale transaction) pertaining to items for which records exist within the items table 304.

An order table 308 is populated with order records, each order record being associated with an order. Each order, in turn, may be associated with one or more transactions for which records exist within the transaction table 306.

Bid records within a bids table 310 each relate to a bid received at the networked system 102 in connection with an auction-format listing supported by an auction application 202. A feedback table 312 is utilized by one or more reputation applications 208, in one example embodiment, to construct and maintain reputation information concerning users. A history table 314 maintains a history of transactions to which a user has been a party. One or more attributes tables 316 record attribute information pertaining to items for which records exist within the items table 304. Considering only a single example of such an attribute, the attributes tables 316 may indicate a currency attribute associated with a particular item, the currency attribute identifying the currency of a price for the relevant item as specified by a seller.

FIG. 4 illustrates a tunable advertisement system 234, in accordance with some embodiments. The tunable advertisement system 234 can be configured to enable someone (e.g., an administrator) to set preferences or other goals for the mixture of different types of advertisements displayed on a website for a certain time period. In some embodiments, tunable advertisement system 234 comprises an ad target tuning module 410 and an ad generation module 420.

The ad target tuning module 410 can be configured to receive a target advertisement goal for a website. In some embodiments, the target advertisement goal comprises at least two goals: a first goal for a first type of advertisement, and a second goal for a second type of advertisement.

In some embodiments, the first type of advertisement is an advertisement for merchandise offered for sale on the website (e.g., website A), which can be referred to as merchandise-based advertisements. The purpose of these merchandise-based advertisements is to direct users of the website to merchandise being offered for sale on the website so that the users will purchase the merchandise. The performance of merchandise-based advertisements can be measured by and based on statistics regarding the sales volume or revenue for the corresponding merchandise and their correlation with the corresponding advertisements (e.g., by using conversion rates). In some embodiments, the second type of advertisement is an advertisement for merchandise offered for sale on a different website (e.g., website B), which can be referred to as advertising-based advertisements. The purpose of these advertising-based advertisements is to generate advertising revenue by directing users of the website to another website. This advertising revenue can be generated using a pay-per-click model or other techniques of charging for online advertising. It is contemplated that other types of advertisements other than merchandise-based advertisements and advertising-based advertisements, as well as other configurations of types of advertisements, are also within the scope of the present disclosure.

The ad target tuning module 410 can provide a user interface for enabling someone to define and submit elements of the target advertisement goal. FIG. 5 illustrates a graphical user interface 500 for tuning advertisement space, in accordance with some embodiments. As shown in FIG. 5, graphical user interface 500 can display a page of a website where a user can provide input to define the target advertisement goal.

In some embodiments, the user can provide revenue goals in the form of dollar (or other currency) amounts. Accordingly, graphical user interface 500 can provide text fields 510a and 510b within which the user can enter revenue goals for advertisements that lead to revenue from merchandise sold on the website (e.g., Merchandise Goal in FIG. 5) and for advertisements that lead to revenue from advertising merchandise sold on a different website (e.g., Advertising Goal), respectively. A selectable user interface element 510c (e.g., a “Submit” button) can be provided to enable the user to submit the input entered into the text fields 510a and 510b.

In some embodiments, the user can provide ratio or percentage goals. Accordingly, graphical user interface 500 can provide text fields 520a and 520b within which the user can enter ratio or percentage goals for advertisements that lead to revenue from merchandise sold on the website (e.g., Merchandise Goal in FIG. 5) and for advertisements that lead to revenue from advertising merchandise sold on a different website (e.g., Advertising Goal), respectively. In some embodiments, the ratio or percentage goal can define what percentage of total revenue for which the user wants the corresponding advertisement type to account (e.g., merchandise-based revenue should account for 40% of the total advertisement-related revenue in the next sales quarter, while advertising-based revenue should account for 60% of the total advertisement-related revenue). In some embodiments, the ratio or percentage goal can define what percentage of the total number of advertisements for which the user wants the corresponding advertisement type to account (e.g., merchandise-based revenue should account for 40% of the total number of advertisements on the website in the next sales quarter, while advertising-based revenue should account for 60% of the total number of advertisements). A selectable user interface element 520c (e.g., a “Submit” button) can be provided to enable the user to submit the input entered into the text fields 520a and 520b.

Although FIG. 5 only shows two text fields for corresponding advertisement type goals per type of goal (e.g., text fields 510a and 510b for revenue amounts, text fields 520a and 520b for percentages), it is contemplated that other numbers of text fields for corresponding numbers of advertisement type goals are also within the scope of the present disclosure. Additionally, other types of user interface elements other than text fields 510a, 510b, 520a, and 520b can be provided to enable the user to provide input to define the goal(s).

FIG. 6 illustrates another graphical user interface 600 for tuning advertisement space, in accordance with some embodiments. In FIG. 6, graphical user interface 600 enables the user to select a target advertisement goal using a slider 610, which may comprise an indicator 614 that may be moved along a track bar 612 in order to adjust the target advertisement goal. The user can move the indicator 614 along the track bar 612 in whichever direction corresponds to the type of advertisements he or she wants to increase. The placement of the indicator 614 along the track bar 612 can be used to determine how much of each type of advertisement the user is requesting. In the example shown in FIG. 6, the indicator 614 is set modestly in favor of advertising-based advertisements over merchandise-based advertisements. A selectable user interface element 620 (e.g., a “Submit” button) can be provided to enable the user to submit the placement of the indicator 614 as an indication of a target advertisement goal. Other configurations are also within the scope of the present disclosure.

Referring back to FIG. 4, the ad generation module 420 can be configured to determine advertisements to display on the website based on the target advertisement goal, and then to cause these advertisements to be displayed on the website. In some embodiments, the ad generation module 420 comprises an algorithm configured to set the proper mix of advertisements for the appropriate time period in order to achieve the target advertisement goal. The ad generation module 420 can set a schedule or a prioritization scheme for displaying the different types of advertisements based on the target advertisement goal. The ad generation module 420 can maintain a record of the advertisements that have been displayed on the website for a certain period, as well as a record of their corresponding types and other related data, such as their associated revenue. These records can be stored in one or more databases 440. In some embodiments, database(s) 440 is incorporated into database(s) 126 in FIG. 1. However, it is contemplated that other configurations are also within the scope of the present disclosure. Accordingly, ad generation module 420 can keep track of what advertisements have been displayed and determine what advertisements are displayed in the future in order to meet the target advertisement goal. For example, the ad generation module 420 can determine that, based on the record, merchandise-based advertisements are behind schedule in terms of meeting the target advertisement goal set by an administrator. In response to this determination, the ad generation module 420 can prioritize merchandise-based advertisements in the selection of advertisements to display, thereby increasing their frequency in order to meet the target advertisement goal for the specified time period. In some embodiments, the ad generation module 420 can adjust a previously set display schedule for the different types of advertisements based on the determination that the adjustment will improve the chances of meeting the target advertisement goal.

FIG. 7 is a flowchart illustrating a method 700 of providing tunable generation of advertisements, in accordance with some embodiments. The operations of method 700 may be performed by a system or modules of a system (e.g., tunable advertisement system 234 in FIG. 4). At operation 710, a target advertisement goal for a website can be received. As previously discussed, in some embodiments, the target advertisement goal comprises at least two goals: a first goal for a first type of advertisement, and a second goal for a second type of advertisement. The target advertisement goal can be received via graphical user interface elements, such as previously described with respect to FIGS. 5-6. At operation 720, it is determined what advertisements to display on the website based on the target advertisement goal. The advertisements can be selected from one or more databases (e.g., database(s) 126 in FIG. 1) based on their classification as a certain type of advertisement (e.g., a merchandise-based advertisement versus an advertising-based advertisement) and what type of advertisement is appropriate to satisfy the target advertisement goal. At operation 730, the advertisements are displayed on the website in accordance with the display configuration determined to be appropriate to satisfy the target advertisement goal. It is contemplated that the operations of method 700 may incorporate any of the other features disclosed herein.

Other factors can be used in addition or as an alternative to the target advertisement goal in determining what advertisements to display on the website. In some embodiments, the determination of what advertisements to display and when can be at least partially based on what stage in the purchase funnel of the website the user is currently in at the time that the advertisement(s) will be displayed. A purchase funnel is a series of stages that a customer goes through on his or her way to making a purchase. At each stage, some percentage of potential customers will not move forward, which makes the shape of this progression look like a funnel. Examples of purchase funnel stages include, but are not limited to, a search query submission stage corresponding to the user viewing a search page of the website before submitting a search query, a search results stage corresponding to the user viewing a search results page, a view item stage corresponding to the user viewing a page for an item offered for sale on the website and being presented with an option to purchase the item, and a purchase initiation stage corresponding to the user viewing a page for completing the purchase of the item subsequent to selecting the option to purchase the item. Other purchase funnel stages are also within the scope of the present disclosure.

In some embodiments, advertisements are assigned purchase funnel stages. These assignments can be manually assigned by a user according to what stage for which the user believes the advertisement to be most appropriate, efficient, or beneficial. These assignments can also be automatically assigned using a program that analyzes the content or other information about the advertisements, using a classification model to determine what stage should be assigned to a particular advertisement.

In some embodiments, the assignments of purchase funnel stages to advertisements can be stored as a mapping in database(s) 440. FIG. 8 illustrates a mapping 800 of advertisements to purchase funnel stages, in accordance with some embodiments. For example, Advertisements 1, 2, and 3 can be assigned to Stage A of the purchase funnel of the website, which can correspond to the search query submission stage of the website. Advertisements 4 and 5 can be assigned to Stage B of the purchase funnel of the website, which can correspond to the search results stage of the website. Advertisements 6, 7, 8, and 9 can be assigned to Stage C of the purchase funnel of the website, which can correspond to the view item stage of the website. Advertisements 10, 11, 12, 13, and 14 can be assigned to Stage D of the purchase funnel of the website, which can correspond to the purchase initiation stage of the website. Other configurations are within the scope of the present disclosure.

The determination of the advertisements to display on the website can be based on the mapping 800 of advertisements to purchase funnel stages. In some embodiments, this consideration of purchase funnel stages in determining what advertisements to display is used in combination with the consideration of the target advertisement goals previously discussed. In some embodiments, this consideration of purchase funnel stages in determining what advertisements to display is used separately from the consideration of the target advertisement goals.

Referring back to FIG. 4, the tunable advertisement system 234 can comprise a purchase funnel stage module 430. In some embodiments, the purchase funnel stage module 430 is configured to determine a purchase funnel stage for a user. Pages of the website can be assigned a purchase funnel stage (e.g., as metadata). The purchase funnel stage module 430 can then determine what stage a user is at based on a determination of what page is currently being displayed to the user. The ad generation module 420 can then use the mapping 800 of advertisements to purchase funnel stages to determine what advertisement(s) correspond to the user's current stage. This determination can be used to select the exact advertisement(s) that will be displayed to the user or to narrow the selection of what advertisements should be displayed to the user for subsequent determination processing, such as the determination processing based on the target advertisement goal. FIGS. 9A-9D illustrate different stages in a purchase funnel of a website, in accordance with some embodiments.

FIG. 9A illustrates a page 900a of the website corresponding to a search query submission stage. As shown in FIG. 9A, this stage can correspond to the user viewing a search page of the website before submitting a search query. One or more advertisements 910a (e.g., Advertisements 1-3 in FIG. 8) can be determined based on the detection of this stage and displayed to the user.

FIG. 9B illustrates a page 900b of the website corresponding to a search results stage. As shown in FIG. 9B, this stage can correspond to the user viewing a search results page. One or more advertisements 910b (e.g., Advertisements 4-5 in FIG. 8) can be determined based on the detection of this stage and displayed to the user.

FIG. 9C illustrates a page 900c of the website corresponding to a view item stage. As shown in FIG. 9C, this stage can correspond to the user viewing a page for an item offered for sale on the website and being presented with an option to purchase the item. One or more advertisements 910c (e.g., Advertisements 6-9 in FIG. 8) can be determined based on the detection of this stage and displayed to the user.

FIG. 9D illustrates a page 900d of the website corresponding to a purchase initiation stage. As shown in FIG. 9D, this stage can correspond to the user viewing a page for completing the purchase of the item subsequent to selecting the option to purchase the item. One or more advertisements 910d (e.g., Advertisements 10-14 in FIG. 8) can be determined based on the detection of this stage and displayed to the user.

FIG. 10 is a flowchart illustrating a method 1000 of providing advertisements based on a purchase funnel of a website, in accordance with some embodiments. The operations of method 700 may be performed by a system or modules of a system (e.g., tunable advertisement system 234 in FIG. 4). At operation 1010, purchase funnel stage assignments for advertisements can be determined. As previously discussed, these assignments can be determined manually or automatically. At operation 1020, a mapping of the advertisements to purchase funnel stages of the website can be stored. At operation 1030, a user can be detected on the website. At operation 1040, the purchase funnel stage for the user on the website can be determined. At operation 1050, one or more advertisements can be determined based on the purchase funnel stage of the user. At operation 1060, the advertisement(s) can be displayed to the user at the corresponding purchase funnel stage on the website. It is contemplated that the operations of method 700 may incorporate any of the other features disclosed herein

It is contemplated that any of the features and/or embodiments disclosed herein may be combined or incorporated into any of the other features and/or embodiments.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 11 is a block diagram of a machine in the example form of a computer system 1100 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation (or cursor control) device 1114 (e.g., a mouse), a disk drive unit 1116, a signal generation device 1118 (e.g., a speaker) and a network interface device 1120.

### Machine-Readable Medium

The disk drive unit 1116 includes a machine-readable medium 1122 on which is stored one or more sets of data structures and instructions 1124 (e.g., software) embodying or utilized by any one or more of the methodologies or functions described herein. The instructions 1124 may also reside, completely or at least partially, within the main memory 1104 and/or within the processor 1102 during execution thereof by the computer system 1100, the main memory 1104 and the processor 1102 also constituting machine-readable media. The instructions 1124 may also reside, completely or at least partially, within the static memory 1106.

While the machine-readable medium 1122 is shown in an example embodiment to be a single medium, the term “machine-readable medium” may include a single medium or multiple media (e.g., a centralized or distributed database, and/or associated caches and servers) that store the one or more instructions 1124 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1124 may further be transmitted or received over a communications network 1126 using a transmission medium. The instructions 1124 may be transmitted using the network interface device 1120 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A computer-implemented method comprising:
receiving a target advertisement goal for a website, the target advertisement goal comprising a first goal for a first type of advertisement and a second goal for a second type of advertisement;
determining, by a machine having a memory and at least one processor, advertisements to display on the website based on the target advertisement goal; and
causing the advertisements to be displayed on the website.

2. The computer-implemented method of claim 1, wherein the first goal comprises a revenue goal for the first type of advertisement, and the second goal comprises a revenue goal for the second type of advertisement.

3. The computer-implemented method of claim 1, wherein the target advertisement goal comprises a ratio of the first type of advertisement to the second type of advertisement.

4. The computer-implemented method of claim 1, wherein the first type of advertisement is an advertisement for merchandise offered for sale on the website, and the second type of advertisement is an advertisement for merchandise offered for sale on a different website.

5. The computer-implemented method of claim 1, wherein determining the advertisements to display on the website comprises determining a total number of advertisements corresponding to the first type of advertisement to display for a predetermined period of time and a total number of advertisements corresponding to the second type of advertisement to display for the predetermined period of time.

6. The computer-implemented method of claim 1, further comprising determining a purchase funnel stage for a user to whom one of the advertisements will be displayed, the determined purchase funnel stage being one of a plurality of purchase funnel stages, each purchase funnel stage corresponding to a distinct stage of depth into an e-commerce purchase process, wherein the determination of the advertisements to display on the website is further based on the determined purchase funnel stage.

7. The computer-implemented method of claim 6, wherein the plurality of purchase funnel stages comprise:
a search query submission stage corresponding to the user viewing a search page of the website before submitting a search query;
a search results stage corresponding to the user viewing a search results page;
a view item stage corresponding to the user viewing a page for an item offered for sale on the website and being presented with an option to purchase the item; and
a purchase initiation stage corresponding to the user viewing a page for completing the purchase of the item subsequent to selecting the option to purchase the item.

8. The computer-implemented method of claim 6, further comprising storing a mapping of advertisements to purchase funnel stages, wherein the determination of the advertisements to display on the website is further based on the mapping of advertisements to purchase funnel stages.

9. A system comprising:
a machine having a memory and at least one processor;
an ad target tuning module, executable by the at least one processor, configured to:
receive a target advertisement goal for a website, the target advertisement goal comprising a first goal for a first type of advertisement and a second goal for a second type of advertisement; and
an ad generation module, executable by the at least one processor, configured to
determine advertisements to display on the website based on the target advertisement goal; and
cause the advertisements to be displayed on the website.

10. The system of claim 9, wherein the first goal comprises a revenue goal for the first type of advertisement, and the second goal comprises a revenue goal for the second type of advertisement.

11. The system of claim 9, wherein the target advertisement goal comprises a ratio of the first type of advertisement to the second type of advertisement.

12. The system of claim 9, wherein the first type of advertisement is an advertisement for merchandise offered for sale on the website, and the second type of advertisement is an advertisement for merchandise offered for sale on a different website.

13. The system of claim 9, wherein determining the advertisements to display on the website comprises determining a total number of advertisements corresponding to the first type of advertisement to display for a predetermined period of time and a total number of advertisements corresponding to the second type of advertisement to display for the predetermined period of time.

14. The system of claim 9, further comprising a purchase funnel stage module configured to determine a purchase funnel stage for a user to whom one of the advertisements will be displayed, the determined purchase funnel stage being one of a plurality of purchase funnel stages, each purchase funnel stage corresponding to a distinct stage of depth into an e-commerce purchase process, wherein the determination of the advertisements to display on the website is further based on the determined purchase funnel stage.

15. The system of claim 14, wherein the plurality of purchase funnel stages comprise:
a search query submission stage corresponding to the user viewing a search page of the website before submitting a search query;
a search results stage corresponding to the user viewing a search results page;
a view item stage corresponding to the user viewing a page for an item offered for sale on the website and being presented with an option to purchase the item; and
a purchase initiation stage corresponding to the user viewing a page for completing the purchase of the item subsequent to selecting the option to purchase the item.

16. The system of claim 14, wherein the purchase funnel category module is further configured to store a mapping of advertisements to purchase funnel stages, wherein the determination of the advertisements to display on the website is further based on the mapping of advertisements to purchase funnel stages.

17. A non-transitory machine-readable storage medium storing a set of instructions that, when executed by at least one processor, causes the at least one processor to perform a set of operations comprising:
receiving a target advertisement goal for a website, the target advertisement goal comprising a first goal for a first type of advertisement and a second goal for a second type of advertisement;
determining advertisements to display on the website based on the target advertisement goal; and
causing the advertisements to be displayed on the website.

18. The storage medium of claim 17, wherein the first goal comprises a revenue goal for the first type of advertisement, and the second goal comprises a revenue goal for the second type of advertisement.

19. The storage medium of claim 17, wherein the target advertisement goal comprises a ratio of the first type of advertisement to the second type of advertisement.

20. The storage medium of claim 17, wherein the first type of advertisement is an advertisement for merchandise offered for sale on the website, and the second type of advertisement is an advertisement for merchandise offered for sale on a different website.
